(19) United States
(12) Patent Application Publication
(10) Pub. No.: US 2023/0267404 A1
(43) Pub. Date: Aug. 24, 2023

(54) SYSTEMS, METHODS, AND APPARATUSES FOR IMPLEMENTING AGGREGABLE, ENVIRONMENT-CONTROLLED MINI-CONTAINERS FOR THE EFFICIENT LOGISTICS OF PERISHABLE PRODUCTS

(71) Applicant: Arizona Board of Regents on behalf of Arizona State University, Scottsdale, AZ (US)

(72) Inventors: Jesus Rene Villalobos, Mesa, AZ (US); Patrick Phelan, Scottsdale, AZ (US); Levi Siwek, Tempe, AZ (US); Keshawa Bandara, Tempe, AZ (US); Derall Riley, Tempe, AZ (US)

(21) Appl. No.: 18/010,357

(22) PCT Filed: Jun. 15, 2021
(86) PCT No.: PCT/US2021/037432

§ 371 Date: Dec. 14, 2022

Related U.S. Application Data
(60) Provisional application No. 63/039,279, filed on Jun. 15, 2020.

(51) Int. Cl. G06Q 10/0832

(52) U.S. Cl. CPC G06Q 10/0832

(57) ABSTRACT

In accordance with embodiments disclosed herein, there are provided herein systems and methods for implementing aggregable, environment-controlled mini-containers for the efficient logistics of perishable products. For example, there is a system for providing efficient transportation logistics of dissimilar perishable products within a transportation unit, in which the system includes: multiple mini-containers, each being configurable to stack and aggregate to consume at least a portion of volume within the transportation unit; a Central Driving Unit (CDU) operable to provide services to each of the mini-containers to maintain the contents of each mini-container; a Central Control Unit (CCU) to receive sensor information from each of the mini-containers and further to issue control parameters for maintaining a specified atmosphere composition within each connected mini-container via the CDU, in which the CCU executes the control parameters for maintaining the specified atmosphere composition within each connected mini-container by activating actuators, in which the actuators manipulate valves at each mini-container, allowing for inflow and egress of atmospheric elements; and in which each of the multiple mini-containers constitute individual modular units configurable to form a single inter-connected and aggregated stack having a size which fits within the available volume of the transportation unit. In related embodiments, the CCU is further configured to transmit data on the status of the mini-containers to the outside world, such as transmitting status information to a remote storage location, or to the cloud, or directly to a centrally located data hub. Other related embodiments are disclosed.

### CLAIM OF PRIORITY

This PCT patent application is related to, and claims priority to, the earlier filed U.S. Provisional Pat. Application No. 63/039,279, filed Jun. 15, 2020, entitled “SYSTEMS, METHODS, AND APPARATUSES FOR IMPLEMENTING AGGREGABLE, ENVIRONMENT-CONTROLLED MINI-CONTAINERS FOR THE EFFICIENT LOGISTICS OF PERISHABLE PRODUCTS,” and having attorney docket number 37684.635P, the entire contents of which being incorporated herein by reference as though set forth in full.

### GOVERNMENT RIGHTS AND GOVERNMENT AGENCY SUPPORT NOTICE

This invention was made with government support under DE-EE0007721 awarded by the Department of Energy. The government has certain rights in the invention.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the invention relate generally to the cold-storage and transportation logistics, and more particularly, to systems, methods, and apparatuses for implementing aggregable, environment-controlled mini-containers for the efficient logistics of perishable products.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

Transportation and logistics needs for certain perishable products can be cost prohibitive, especially for small growers of fresh produce which have conventionally lacked access to time efficient and cost effective harvest logistics.

Further still, certain products, such as medicines, require precise temperature and traceability, and yet, do not always justify the use of an entire air conditioned semi-trailer (e.g., an HVAC controlled semi-trailer) dedicated specifically to those products, as doing so drastically increases the cost and complexity of logistics, even when the physical volume may be small or substantially less than space provided by a dedicated semi-trailer.

Moreover, inefficient use of transportation logistics increases the risk of food spoilage and thus food waste as well as non-optimal energy consumption, each of which contribute to an excessive carbon-footprint for the per-unit distribution of such specialty products and perishables.

Growers and farmers producing small-scale yields as well as specialty product manufacturers requiring precise temperature (e.g., cold storage) and traceability throughout the supply chain may therefore benefit from the systems, methods, and apparatuses for implementing aggregable, environment-controlled mini-containers for the efficient logistics of perishable products, as described herein.

### BRIEF DESCRIPTION OF THE DRAWINGS

Embodiments are illustrated by way of example, and not by way of limitation, and can be more fully understood with reference to the following detailed description when considered in connection with the figures in which:

FIG. 1 depicts a single exemplary mini-container 100 in accordance with described embodiments;

FIG. 2 depicts an exemplary set of stacked mini-containers having both air supply and return connections provisioned within the aggregated stack 200, in accordance with described embodiments;

FIG. 3 depicts the connection ports (305 and 310) via which to connect hoses to the mini-containers 300, thus permitting the CDU to provide services to the mini-containers 300 so as to maintain the contents of the mini-containers, in accordance with described embodiments;

FIG. 4 depicts an exemplary mini-container from an aggregated stack highlighting CDU and CCU connections and valves, in accordance with described embodiments;

FIG. 5 depicts a centralized supply service 505, a centralized return service 510, and associated connections traversing mini-containers in an aggregated stack, in accordance with described embodiments.

FIG. 6 depicts an exemplary aggregate stack of mini-containers powered by solar photovoltaics 600, in accordance with described embodiments;

FIG. 7 depicts an exemplary schematic 700 for the overall system, in accordance with described embodiments;

FIG. 8 depicts an exemplary flow process 800 for a fresh produce supply chain, in accordance with described embodiments;

FIGS. 9A and 9B depict a flow diagram illustrating a method for a novel approach for the stacking, connecting, and transport of aggregable, environment-controlled mini-containers for the efficient logistics of perishable products, each of which are uniquely identifiable to the CCU via traceable per-container identifier, in accordance with disclosed embodiments; and

FIG. 10 illustrates a diagrammatic representation of a machine in the exemplary form of a computer system, in accordance with one embodiment.

### DETAILED DESCRIPTION

Described herein are systems, methods, and apparatuses for implementing aggregable, environment-controlled mini-containers for the efficient logistics of perishable products.

For example, there is a system for providing efficient transportation logistics of dissimilar perishable products within a transportation unit, in which the system includes: multiple mini-containers, each being configurable to stack and aggregate to consume at least a portion of volume within the transportation unit; a Central Driving Unit (CDU) operable to provide services to each of the mini-containers to maintain the contents of each mini-container; a Central Control Unit (CCU) to receive sensor information from each of the mini-containers. According to such an embodiment, the CCU is further configured to monitor and track unique ID for each mini-container which thus in turn allows the CCU to independently monitor each mini-container and its contents continuously. In related embodiments, the CCU is further configured to transmit data on the status of the mini-containers to the outside world, such as transmitting status information to a remote storage location or transmitting status information into the cloud or directly to a centrally located data hub that keeps track of all the mini-containers, their status, and their contents, across the entire platform, regardless of location or what transport vehicle or configuration any given mini-container happens to be presently operating within.

The exemplary embodiment further includes the CCU being configured to issue control parameters for maintaining a specified atmosphere composition within each connected mini-container via the CDU, in which the CCU executes the control parameters for maintaining the specified atmosphere composition within each connected mini-container by activating actuators, in which the actuators manipulate valves at each mini-container, allowing for inflow and egress of atmospheric elements; and in which each of the multiple mini-containers constitute individual modular units configurable to form a single inter-connected and aggregated stack having a size which fits within the available volume of the transportation unit.

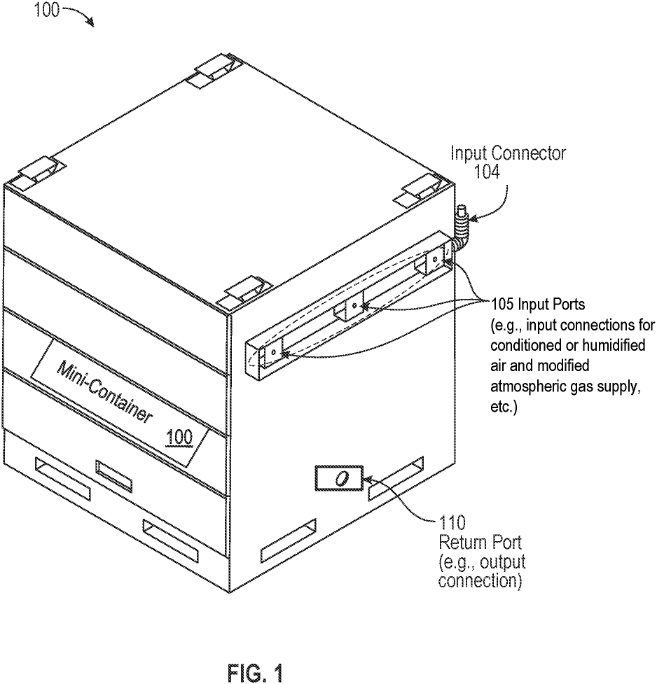

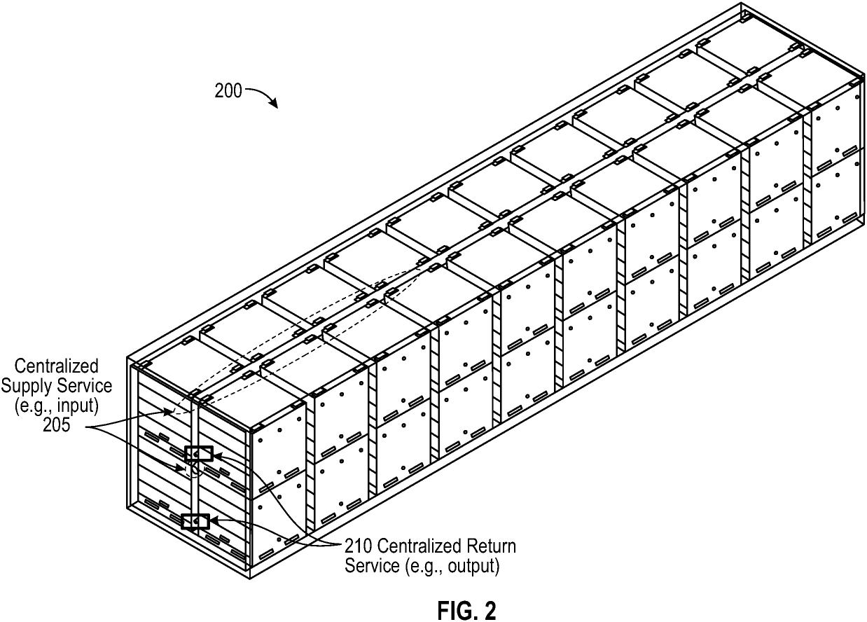

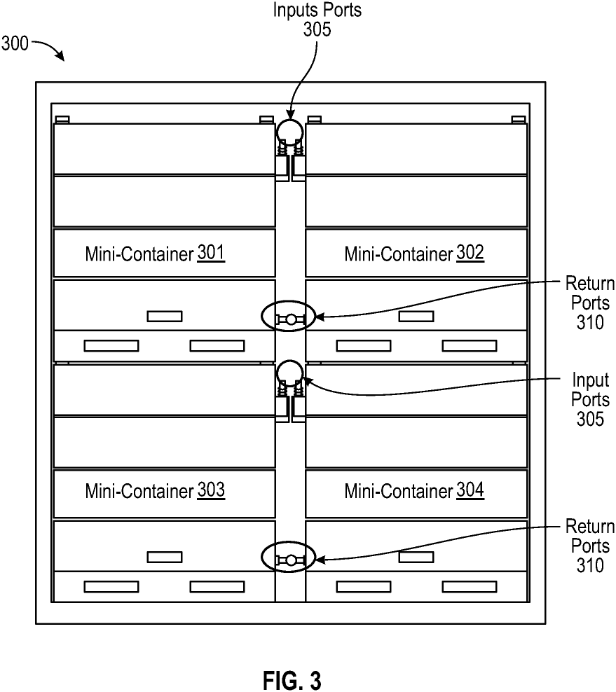

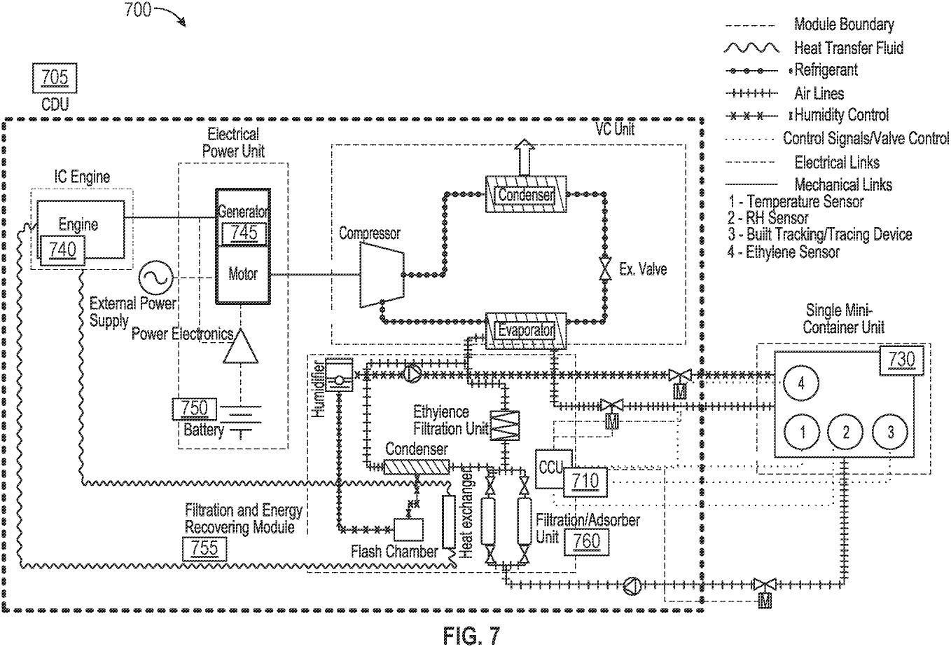

For example, there are various embodiments described in greater detail below, including, for example: (1) a standardized-dimension hermetic box or mini-container whose temperature and atmospheric conditions will be individually controlled (see FIG. 1). Further disclosed is (2) the mini-container having a design which acts as a lego-type component that can be aggregated to fit the available volume in most freight vehicles (see FIG. 2), the design including a set of connecting devices between the Central Driving Unit (CDU) and the mini-containers in a stacked configuration (refer to FIG. 3 which depicts input ports 305 for services from the CDU through flexible hoses and return ports 305 to the CDU). Further disclosed is (3) a central driving unit (CDU) which operates as the unit in charge of providing services to maintain the contents of the mini-containers while minimizing energy use (refer to the schematic presented at FIG. 7). And further disclosed is a Central Control Unit (CCU) which is housed along with the CDU and receives sensor information from each of the containers and other external sources (also depicted within the schematic presented at FIG. 7).

Generally speaking, disclosed embodiments of the invention concern a mini-container (or box) of a temperature/atmosphere controlled, non-active, of standard size whose dimensions allow for the incremental use of units to fit to the needs of freight transportation in standard (non-refrigerated) transportation units such as dry-vans, flat platforms, etc., without necessarily requiring the entirety of a dedicated HVAC controlled transport unit.

Because each mini-container has its own, independent, temperature/atmosphere controls and traceability ID, it is thus possible for products from different food producers and/or product manufacturers to be transported within the same truck or transport unit without loss of individual traceability and while ensuring there is no cross-contamination. For example, produce from multiple different food producers, each with different temperature and environmental specifications during transport and each with unique identifiers, may nevertheless be co-located within a single larger transport unit (e.g., within a single non-refrigerated and non-HVAC controlled semi-trailer, etc.) by having each of the different food producers’ goods segmented into their own respective aggregable, environment-controlled mini-containers.

In such a way, it is possible to greatly reduce logistics costs and as well as provide efficient entry points into the cold chain for small producers or manufacturers of low-volume specialty products, such as medicines and other therapeutics.

The described mini-containers provide directly the basis for efficient pick-up and delivery routing; and indirectly provide the basis for the realization of a concept that has been proposed in theory but never effectively implemented in practice, notably, the “physical” internet. In this case, each mini-container thus provides the smallest, efficient and standard unit by which to transport fresh produce throughout a highly automated logistics network.

Thus, practice and implementations of the disclosed embodiments have the potential to revolutionize fresh supply chains by, for example, (i) permitting for multiple environmental zones without additional hardware, (ii) embodying a design which is optimized to efficiently fit into most truck or standard transport unit configurations, (iii) allowing for traceability of individual products, (iv) preventing cross-contamination through isolation of diverse goods via the per-product dedicated mini-containers, (v) embodying a design optimized for efficient “first mile” logistics of small growers, (vi) purposeful leveraging of pre-existing equipment not conforming to new environmental/food security regulations, and by (vii) allowing for the optimization of pickup and delivery routing, which is one of the main sources of CO2 and other pollution. Furthermore, the disclosed embodiments allow the transformation of a non-environmentally controlled structure into a cold storage facility.

FIG. 1 depicts a single exemplary mini-container 100 in accordance with described embodiments.

Central to the disclosed embodiments is the concept of a specially developed temperature and atmosphere controlled, non-active, mini-container (or box) of a standard size having dimensions which allow for the incremental use of units to be added so as to fit the needs of freight transportation in standard (non-refrigerated) transportation units such as dry-vans, flat platforms, etc.

For example, each one of the mini-containers may be passive, that is to say, the boxes are themselves not refrigerated, but are configurable to be connected with Central Driving Unit or “CDU” that provides all needed services, including providing refrigerated air and moist humidified air so as to permit the correct atmosphere composition within each connected mini-container. The CDU may receive for example, external electricity input, or have an associated electrical power unit, battery bank, or internal combustion engine. These power sources may power a vapor compressor system and/or filtration and energy recovery unit associated with the CDU. Each one of the mini-containers further includes a unique traceability ID and a sensor that keeps track of the temperature, moisture level, vibrations and atmospheric composition within each mini-container.

According to further embodiments, the sensors send the information to a Control/Communications Unit or “CCU” which is, according to such an embodiment, housed within the Central Driving Unit (CDU). This CCU actuates and controls valves associated with each mini-container to maintain the environmental conditions required by the product stored in each mini-container.

In such a way, use of the mini-container will therefore reduce logistics costs by making it possible to transport dissimilar products using the same transportation unit, cooling only the volume of space which is actually required to transport a reduced load and allowing the aggregation of products of different sources without losing traceability and without using more than one transportation unit to accommodate the dissimilar environmental conditions during transport.

Further still, the use of the mini-container reduces potential food waste by allowing for the introduction of perishable products in the cold chain without delay and the better utilization of energy allows for the reduction of the carbon footprint of perishable products.

However, use of the mini-container concept is not limited strictly to consumable food products. Rather, use of the mini-container is further applicable to non-food perishable items, such as medicines and other manufactured products that require a precise temperature and traceability throughout the logistics supply chain.

Under current conditions it is not possible to mix products from different growers in the same truck because of potential cross-contamination, dissimilar environmental requirements and loss of traceability. Consequently, growers are often forced to use a full-truck service, even if the crops they need to transport do not require that much capacity. This results in more expensive transportation and the inability of small growers, who do not have enough products to ship using full-truck services, to access efficient logistics services.

Consider, for example, the potential efficiencies which may be realized through practice of the disclosed in view of the following example. Consider a rate price differential between a dry (not refrigerated) van and reefer (refrigerated) one of about 0.40 $/mile. It has been reported that typically fresh food travels about 1500 miles from farm to consumer and USDA reported that about 37.473 million tons of fresh food were shipped (over 1.8 million shipments by truck using an unrealistic assumption that each truck carries 20 tons) in 2018. Because practice of the invention helps to balance the weight/volume transportation dilemma in addition to providing better logistics for short trips (e.g., those less than 500 miles, whose rates are much higher than lengthier trips), it may be safely assumed that practice of the invention will provide savings of 1.00 $/mile for 10% of all the trips in the USA. That would result in savings of over 280 million dollars per year of savings to the shippers.

Thus, there is a ready incentive for the described mini-container system to be deployed, for instance, through the practice of a lease and depot scheme similar to that which is used by sea containers or via exchange sites used by certain types of pallets.

The proposed mini-containers allow the aggregation of small amounts of crops from different growers in a standard, non-refrigerated vehicle, yielding considerable costs and energy savings.

With reference to FIG. 1, the mini-container 100 provides a standardized-dimension hermetic box or mini-container whose temperature and atmospheric conditions are individually controlled. Control of such conditions is achieved by providing services to each connected mini-container from a Central Driving Unit (CDU) as will be described in greater detail below. Notably, however, each mini-container is specially configured with both an input connector 104 leading to multiple input ports 105 as well as a return port 110 operable as an output connection from the mini-container, via which to cycle in and cycle out various services. As shown here, the mini-container includes three (3) distinct input ports or input connections, thus permitting the CDU to provide each of, by way of example, conditioned air, humid or moist air, as well as non-atmospheric gases and modified atmospheric gas supply, such as ethylene or N2, as needed for the particular implementation. Certain implementations may not require the use of all three ports, for instance, requiring only cool or conditioned air, whereas other implementations may require the use of multiple ports or may require gases other than ethylene, depending on the contents of the mini-containers during logistics transport.

The design of the mini-container is such that it acts as a “lego-type” component that can be aggregated to fit the available volume in most freight vehicles (refer to the set of stacked mini-containers as depicted at FIG. 2). However, the mini-container can also be used in warehouses or open spaces to preserve the shelf-life of its contents or to provide pre-cooling services. The design of the mini-container is such that it allows for rapid sanitation to comply with food and pharmaceutical regulations.

While an exemplary material used for the construction of the mini-container is aluminum, other better insulating materials may alternatively be utilized as particular applications require. The mini-container does not have its own system for temperature or atmospheric control according to the described embodiments. Rather, it is connected through different systems to a Central Driving Unit (CDU) and a Central Control Unit (CCU) that will provide these services.

In other words, the mini-container is a static device that, in order to operate in the manner described herein, needs to be connected with a CDU and a CCU.

The mini-container includes sensors to monitor the relevant conditions of its contents. The data collected by these sensors is sent to the CCU with the corresponding mini-container identifier (a unique traceability ID) for its processing, storage and retransmission. The use of hermetic mini-containers and a unique traceability ID allows for the aggregation of products from different producers in a single vehicle and yet, still be compliant with food safety and other regulations.

FIG. 2 depicts an exemplary set of stacked mini-containers having both air supply and return connections provisioned within the aggregated stack 200, in accordance with described embodiments. In particular, the set of stacked mini-containers depicted here demonstrate how the mini-containers fit within the volume of a standard container, such as fitting within a single transport unit, be that a single tractor trailer, delivery van, or other transport logistics vehicle.

As may be observed between the respective left and right stacks on both the top and bottom layers of mini-containers within the aggregated stack 200, there are centralized supply services (e.g., input) 205 connections provided via which the CDU provides air supply to each of the respective mini-containers. Each mini-container is then in turn connected with the centralized supply service 205 via input connection ports integrated within each of the mini-containers. Similarly, there are also centralized return services (e.g., output) 210 connections provided via which the CDU collects, returns, re-captures, or otherwise receives back air and gases from each of the respective mini-containers, thus providing a complete cycle. As before, each mini-container is connected with the centralized return service 205 via output ports integrated within each of the mini-containers.

One unique aspect achievable through practice of the invention is that the mini-containers provide directly the basis for efficient pick-up and delivery routing; and indirectly, the basis of a concept that has been proposed in theory but never effectively implemented: the physical internet.

Because the mini-container provides a small, efficient and standardized unit to transport fresh produce through a highly automated logistics network, it is thus possible to revolutionize fresh supply chains through the realization of reduced cost, greater flexibility, improved efficiencies, as well as the potential to reduce food waste by allowing the growers to introduce the harvested crops (in the case of agricultural commodities) into the cold-chain as soon as possible, thus reducing the decay of the product caused by exposure to ambient temperatures for extended periods of time.

Yet another potential advantage related to food waste is the potential preservation from farm-to-market in the same container without the need to transship the product from one vehicle to another, reducing the time the product is exposed to less-than-ideal environmental conditions.

As will be appreciated by those skilled in the cold chain logistics field, the problem of food waste is an extremely important issue for the global economy. It is estimated that food waste in fresh produce supply chains ranges between 30 to 50%. While in the developed world, most of the waste is at the end of the supply chain, i.e., the consumer side; in the developing world most of the waste is at the beginning of the supply chain, i.e., at the grower side. Practice of the described invention significantly contributes to reducing this food waste problem.

FIG. 3 depicts the connection ports (305 and 310) via which to connect hoses to the mini-containers 300, thus permitting the CDU to provide services to the mini-containers 300 so as to maintain the contents of the mini-containers, in accordance with described embodiments.

As shown here, input ports 305 into the mini-containers permit the Central Driving Unit (CDU) to provide services to connected mini-containers via the input ports 305 and return ports 310 permit the CDU to accommodate return or collection service from the mini-containers. In such a way, the CDU may provide and cycle services, such as conditioned air, humidified or moist air, or other modified atmosphere gases (e.g., such as ethylene or Nitrogen gas) into the hoses connected with the mini-containers via the depicted input port connections 305 and return or re-cycle such services from the mini-containers via return ports 310.

Notably, there are depicted four mini-containers in a stacked configuration, with mini-containers 301 and 302 forming the top stack and mini-containers 303 and 304 forming the bottom stack. Each of the mini-containers 300 are configured with various ports, including input ports 305 as depicted, via which flexible hosing may be affixed to interface the input ports 305 of the mini-containers with input service originating from the CDU (e.g., input services including conditioned air and moist/humid air or optionally non-atmospheric gases, such as ethylene). Similarly, return ports 310 of the mini-containers may be connected via flexible hosing to a return via which to return air and gases from the mini-containers back to the CDU. As depicted above at FIG. 2, a centralized return may be utilized for all the mini-containers on the top stack and another centralized return may be utilized for all the mini-containers on the bottom stack. These centralized returns may or may not be joined at or prior to the CDU, depending on the implementation. Similarly, centralized input pipes or hoses may be utilized for providing services from the CDU to the input ports 305 of the respective mini-containers within each stack. Again, depending on the configuration chosen, a single CDU may service the entirety of the aggregated set of mini-containers or if needed, a CDU may be utilized for each of the top and bottom stacks of mini-containers, based on the respective size of the stacks and total quantity of units supported.

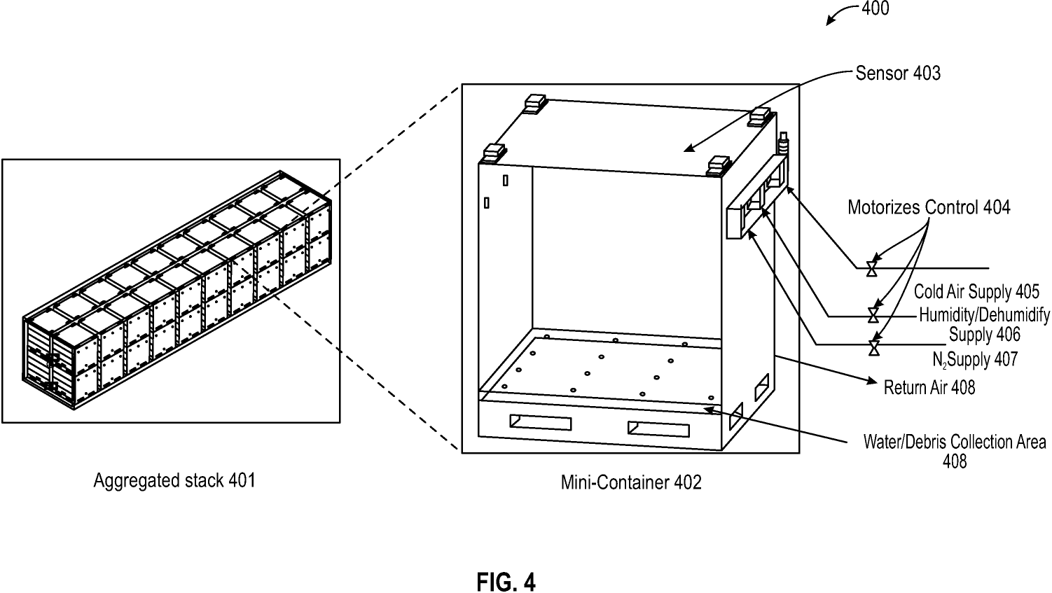

FIG. 4 depicts an exemplary mini-container 402 from an aggregated stack highlighting CDU and CCU connections and valves 400, in accordance with described embodiments.

As shown here, mini-container 402 from aggregated stack 401 has several connections to other components of the system for providing efficient transportation logistics of dissimilar perishable products within a transportation unit. For example, sensor 403 connects to Central Control Unit (CCU) and support both sensing and traceability functionality to monitor atmospheric elements of the atmospheric composition/environment inside mini-container 402. Such atmospheric elements may include, for example, temperature, relative humidity, carbon dioxide and other greenhouse gases, nitrogen and other atmospheric gases, ethylene gas, as well as vibration. Traceability function of sensor 403 allows for the transmission, recording, and monitoring in real time of the location and atmospheric composition/environment of mini-container 402. A unique ID may also be assigned to mini-container 402 for traceability and control purposes.

Inputs from, for example the Central Driving Unit (CDU) 602 or Central Supply Service 505 may include cold air supply 405, humidity/dehumidify supply 406, and nitrogen N₂ supply 407. Motorized control valves 404 control the supply of atmospheric elements such as elements 405-407 entering mini-container 402. According to certain embodiments, the manipulation (i.e. opening and closing) of these valves may be activated by actuators at each mini-container 402. Outputs from mini-container 402 such as return air 408 may feed into Centralized Return Service 510. There is also water/debris collection area 408 at the bottom of mini-container 402 to collect liquid and debris during storage and transportation of goods such as produce in mini-container 402.

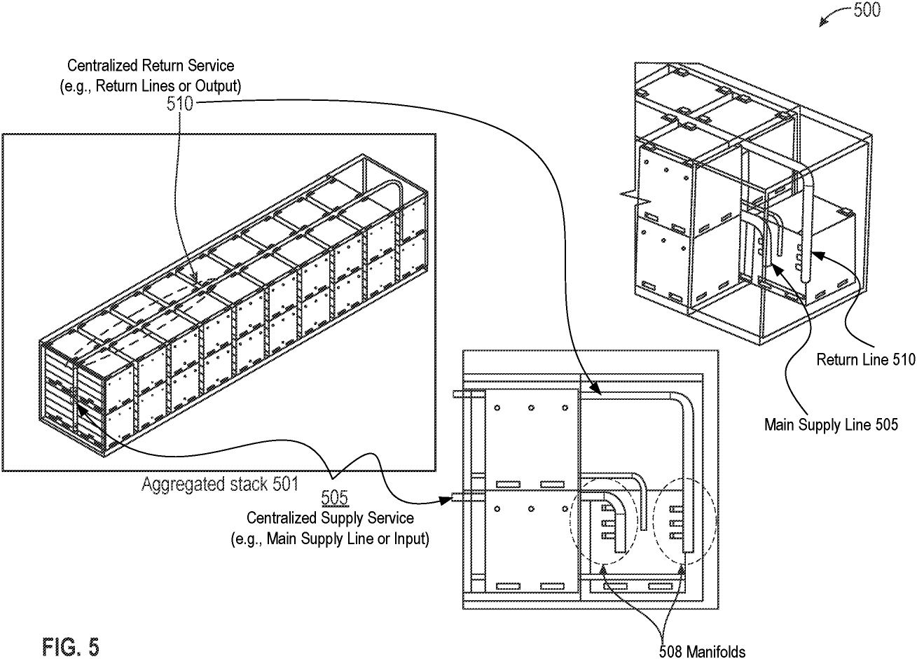

FIG. 5 depicts a centralized supply service 505, a centralized return service 510, and associated connections traversing mini-containers in an aggregated stack, in accordance with described embodiments.

As shown here, there is both a centralized supply service (e.g. main supply line or input) 505 and a centralized return service (e.g., return lines or output) 510 as was previously described in FIG. 2, each of which traverse through the collection mini-containers 402 that are a part of aggregated stack 501. The return line 510 is configurable to route atmospheric elements such as nitrogen or ethylene back to the CDU from the mini-containers. According to certain embodiments, one or both of centralized supply service 505 and centralized return service 510 may receive connections from other, smaller pipes to maintain equal pressure in the system, as depicted by manifolds 508.

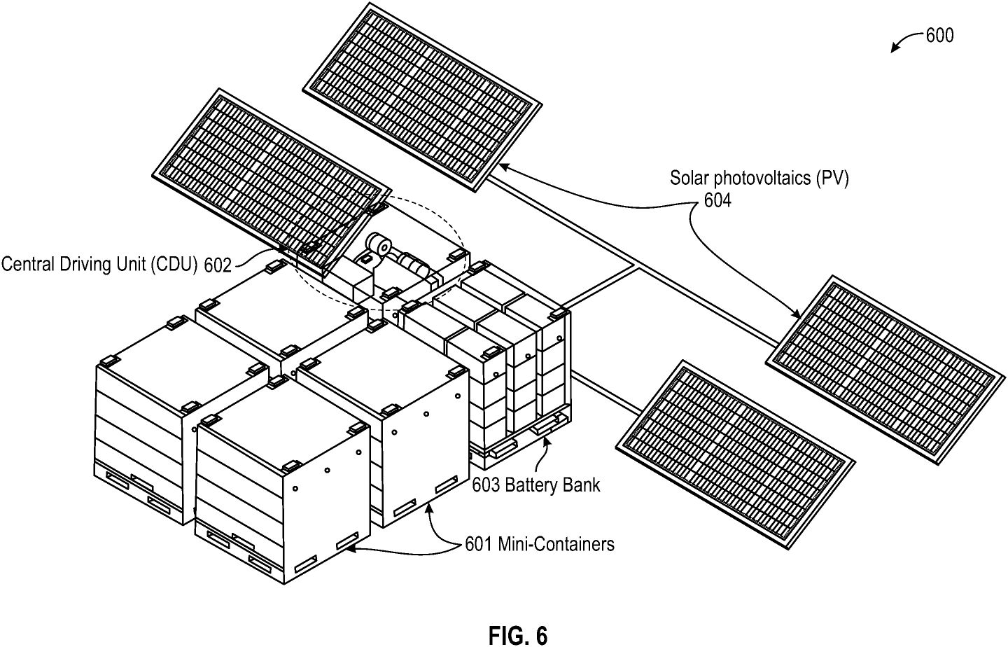

FIG. 6 depicts an exemplary aggregate stack of mini-containers powered by solar photovoltaics 600, in accordance with described embodiments.

As shown here, the combination of mini-containers 601 and CDU 602 with associated battery bank 603 can be powered by solar photovoltaics (PV) 604 to provide electric power to maintain required environmental conditions while decreasing greenhouse gas emissions and carbon footprint.

According to certain embodiments, a number of mini-containers 601 and one or more CDUs 602 can be positioned at a farm in preparation for harvest and loading. The CDU 602 can be powered by solar panels 604, thus enabling pre-cooling and any needed preconditioning with ethylene, moisture, etc. to be achieved with only renewable energy and no grid connection. The aggregate stack of mini-containers powered by solar photovoltaics 600 may also be deployed in other locations such as remote locations, war zones, and areas affected by natural disasters, or other such locations where grid energy or traditional energy sources are not available or desired.

According to certain other embodiments, solar photovoltaics 604 may be supplemented with grid electricity and/or fuel-driven generators, or supplemented or replaced with other alternative energy sources such as wind or hydropower.

FIG. 7 depicts an exemplary schematic 700 for the overall system, in accordance with described embodiments. In particular, there is further depicted each of the Central Driving Unit (CDU) 405 and the Central Control Unit (CCU) 410 which operate within the system to provide services to each of the mini-containers within a connected set (refer to the connected set of mini-containers presented at FIG. 2).

For instance, there is a set of connecting devices between the CDU 705 and the mini-containers 730. Each of the mini-containers 730 will have multiple inlet and one outlet cavities. Each one of these cavities will allow the introduction of hoses (or flexible pipes) to connect to the CDU 705. A valve, unique to each mini-container, in each of the hoses allows for the control of the temperature and atmosphere inside the mini-container. Each one of the valves is remotely controlled by the CCU 710 according to the information provided by the sensors inside the mini-containers and the required conditions by the product in each of the containers.

There are multiple hoses connecting to the inlet cavities. The depicted hoses contain: cold air, moist air and modified air. The modified air will be used in case that a product requires specific atmospheric conditions different from those provided by regular air (e.g., such as ethylene gas, etc.). The outlet hose will be used to return the air and humidity coming from each of the mini-containers back to the CDU. Each one of the flow control valves has an actuator. These actuators are energized by two single wires, common to all the valves. The CCU 710 controls the operation of the actuators through control lines or wirelessly. In either case a decoder activates the proper actuators.

The Central Driving Unit (CDU) 705 shown here is the unit in charge of providing the services to maintain the contents of the mini-containers while minimizing energy use and carbon footprint. The CDU 705 may be housed within one or two mini-containers, depending on the energy required by the products inside the other mini-containers and is composed of three modules according to the embodiment shown here. Specifically, (1) power, (4) air conditioning and (3) filtration/energy recovery.

The power module of the CDU 705 provides the electric power that will be used by the other modules. There are two different versions of this module: one with an internal combustion (IC) engine and one without it. In the former, the IC engine 740 drives a generator 745 that in turn recharges a set of batteries 750 which provides the energy to energize the rest of the system. In the latter, the power stored in the batteries is used to energize the rest of the system. In either case, the power system will allow using an external source of energy (such as the grid) to charge the batteries.

According to certain embodiments, the CDU 705 further contains a vapor-compression refrigeration (or heat pump) cycle for maintaining the desired temperature inside the mini-containers, a filtration/adsorber 760 unit for controlling the relative humidity and ethylene levels inside the mini-containers, and a fan or other prime mover to achieve the desired air flow through each mini-container. The vapor-compression cycle and fan will be powered by the batteries, which in turn are recharged either by the IC engine or by an external power supply. The filtration/adsorber 760 unit may be regenerated with waste heat from the condenser of the vapor-compression cycle, and/or waste heat from the IC engine. The ethylene and humidity control may be achieved by the adsorption module integrated with photocatalyst oxidation and ventilation. The efficient desorption methods to be used may include microwave or ultrasound assisted desorption. Energy recuperation 755 will be considered for makeup air cooling in the ventilation process.

Further provided in accordance with the disclosed embodiments is a Central Control Unit or CCU 710 which is housed along with the CDU within one of the mini-containers, within the same mini-container, or within a co-located mini-container, so as to permit local electronic monitoring and communication between the CCU 710 and the CDU 705.

As described herein, the CCU 710 receives sensor information from each of the containers and other external sources such as the ambient temperature of the current and next locations planned for the mini-containers. The CCU 710 further records and processes this information to make individualized decisions to control the valves associated with each mini-container to maintain the desired conditions using the optimal amount of energy.

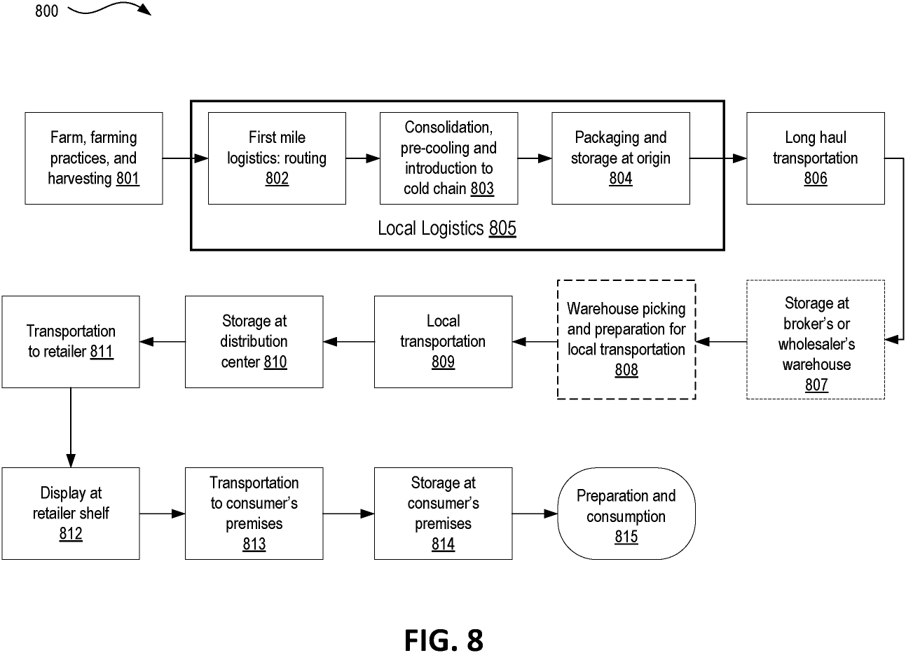

FIG. 8 depicts an exemplary flow process 800 for a fresh produce supply chain, in accordance with described embodiments.

As shown here, farm, farming practices, and harvesting 801 often lack logistics capacity and service providers, including lack of open-access facilities for processing, packaging, pre-cooling, and cold storage. Other obstacles in the fresh produce supply chain may include, for example, a lack of critical mass for an individual grower to access efficient logistics such as full truck loads and efficient processing. Furthermore, aggregation of products from different growers in a vehicle is made difficult because of regulation and incompatibility of products. There is also a lack of marketing, planning and negotiating platforms to make an efficient demand-supply match.

Local logistics 805 provides for solutions to these challenges by, for example, storing/transporting only one type of produce or good in each mini-container. The mini-containers in plurality or when assembled into an aggregate stack such as aggregate stack 200 allow for the aggregation of small harvest from different growers, while keeping goods separated in different mini-containers. Combined with efficient routing and scheduling, these features considerably reduce the cost of first mile logistics - routing 802. Furthermore, independent control over the environment for each mini-container in isolation from other mini-containers as part of the consolidation, pre-cooling and introduction to cold chain 803. The atmospheric/environmental conditions within any given mini-container to be controlled, for example via the CCU, may include temperature, relative humidity, and percent compositions of ethylene gas and carbon dioxide gas.

Packaging and storage at origin 804 allows for the contents of each mini-compartment to traceable and the environmental history (atmospheric/environmental conditions within each mini-compartment) to be recorded. Thus, mini-containers integrate these functions without the need for additional handling and connect farmers and growers directly to the final customer without the need to unlock the mini-container, thus preserving shelf-life of the stored goods, reducing food waste and carbon footprint, as well as providing full traceability.

According to certain embodiments, packaging and storage at origin 804 may involve a remote location lacking grid-like infrastructure for power, water and temperature connections such as sub-Saharan Africa or a region impacted by a natural disaster or war. In such a situation, mini-containers 100 may be connected into an aggregated stack to form a storage facility, assisting with for example, hospital development and medical care by agencies such as the Federal Emergency Management Agency (FEMA). This is especially crucial to store and maintain perishable food items or medicines such as COVID-19 vaccines in mini-container 100.

Flow process 800 continues with long haul transportation 806, with mini-containers, according to certain embodiments connected in an aggregate stack, undergoing storage at broker’s or wholesaler’s warehouse 807. Next, there is warehouse picking and preparation for local transportation 808. This may be followed by, for example, local transportation 809, storage at distribution center 810, transportation to retailer 811, display at retailer shelf 812, transportation to consumer’s premises 813, storage at consumer’s premises 814, and finally preparation and consumption 815.

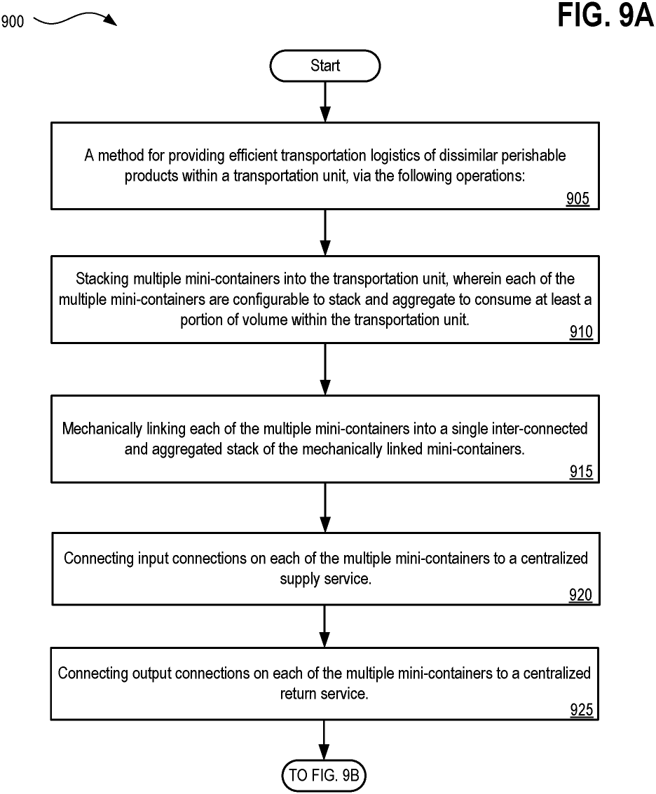

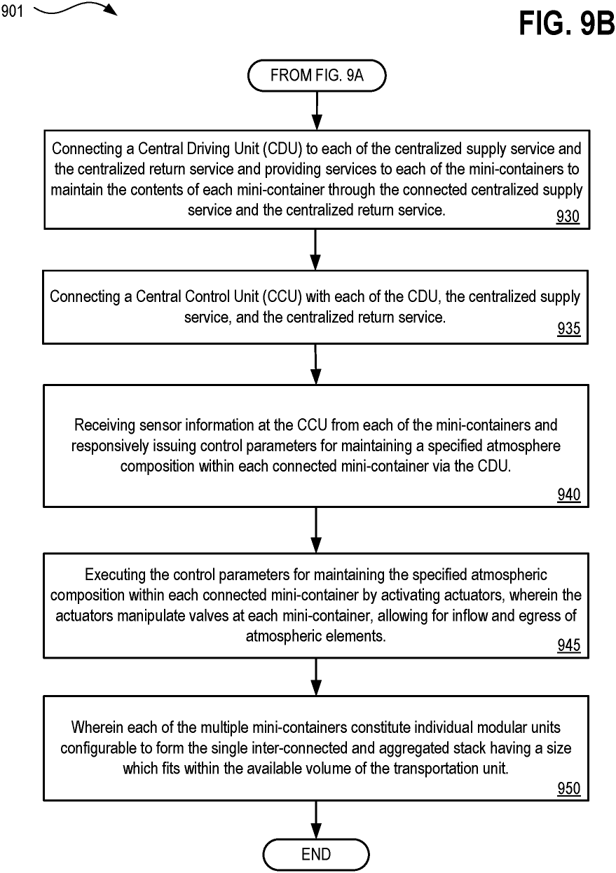

FIGS. 9A and 9B depict a flow diagram illustrating a method 900-901 for a novel approach for the stacking, connecting, and transport of aggregable, environment-controlled mini-containers for the efficient logistics of perishable products, each of which are uniquely identifiable to the CCU via traceable per-container identifier, in accordance with disclosed embodiments.

Method 900-901 may be partially performed by processing logic and control logic that may include specially configured hardware (e.g., circuitry, dedicated logic, programmable logic, microcode, etc.), software (e.g., instructions run on a processing device) to perform various operations such as receiving, sensing, instructing, maintaining, managing, updating, retrieving, parsing, persisting, exposing, loading, executing, operating, generating, storing, maintaining, creating, returning, presenting, interfacing, communicating, transmitting, querying, processing, providing, determining, triggering, displaying, sending, etc., in pursuance of the systems and methods as described herein. Other operations are performed by specially configured electro-mechanical devices, pneumatic devices, or mechanical interconnect devices, or hydraulic devices. Some of the blocks and/or operations listed below are optional in accordance with certain embodiments. The numbering of the blocks presented is for the sake of clarity and is not intended to prescribe an order of operations in which the various blocks must occur.

With reference first to method 900 as depicted at FIG. 9A, there is a method for providing efficient transportation logistics of dissimilar perishable products within a transportation unit (block 905), wherein the method includes the following operations:

At block 910, the method includes stacking multiple mini-containers into the transportation unit, wherein each of the multiple mini-containers are configurable to stack and aggregate to consume at least a portion of volume within the transportation unit.

At block 915, the method includes mechanically linking each of the multiple mini-containers into a single inter-connected and aggregated stack of the mechanically linked mini-containers.

At block 920, the method includes connecting input connections on each of the multiple mini-containers to a centralized supply service.

At block 925, the method includes connecting output connections on each of the multiple mini-containers to a centralized return service.

The flow diagram then advances to method 901 as set forth at FIG. 9B.

Beginning with block 930 at FIG. 9B, the method includes connecting a Central Driving Unit (CDU) to each of the centralized supply service and the centralized return service and providing services to each of the mini-containers to maintain the contents of each mini-container through the connected centralized supply service and the centralized return service.

At block 935, the method includes connecting a Central Control Unit (CCU) with each of the CDU, the centralized supply service, and the centralized return service.

At block 940, the method includes executing processing logic via a CPU for receiving sensor information at the CCU from each of the mini-containers and responsively issuing control parameters for maintaining a specified atmosphere composition within each connected mini-container via the CDU.

At block 945, the method includes executing the control parameters for maintaining the specified atmospheric composition within each connected mini-container by activating actuators, wherein the actuators manipulate valves at each mini-container, allowing for inflow and egress of atmospheric elements.

At block 950, the method further indicates that each of the multiple mini-containers constitute individual modular units are configurable to form the single inter-connected and aggregated stack having a size which fits within the available volume of the transportation unit.

The operations of method 900-901 then end.

According to another embodiment of method 900-901, the services provided by the Central Driving Unit (CDU) include at least conditioned air and moist humidified air to manage a specified atmosphere composition within each connected mini-container.

According to another embodiment of method 900-901, the services provided by the Central Driving Unit (CDU) further includes the removal or supply of ethylene gas to one or more of the connected mini-containers.

According to another embodiment of method 900-901, each of the CDU and the CCU are embodied within one or more mini-containers co-located with a plurality of additional mini-containers having perishable products contained therein.

According to another embodiment of method 900-901, each connected mini-container includes its own traceable identifier.

According to another embodiment of method 900-901, each connected mini-container is associated with a distinct customer specifying a unique atmosphere composition for the associated mini-container uniquely identifiable via a traceable identifier corresponding each mini-container to only one of a plurality of distinct customers; and in which the CDU manages temperature and atmosphere controls for each of the distinct customers, associated mini-container and prevents cross-contamination of perishable food products being shipped by each of the distinct customers by isolating the food products shipped by each of the distinct customers into separate mini-containers within the larger single inter-connected and aggregated stack being shipped within the available volume of the transportation unit.

According to another embodiment of method 900-901, each connected mini-container includes specified atmosphere composition including at least a mandated temperature and humidity range which is maintained within each respective mini-container by the CDU and which is configurable to be different than other connected mini-containers.

According to another embodiment of method 900-901, the CDU includes an internal combustion engine to re-charge batteries of the CDU, in which the batteries provide stored energy to an HVAC system embodied within the CDU.

According to another embodiment of method 900-901, the CDU includes rechargeable batteries and in which the rechargeable batteries of the CDU receive external power when not in transport, in which the batteries provide stored energy to the systems embodied within the CDU.

According to another embodiment of method 900-901, the transportation unit includes one of a “dry-van” or a “dry-trailer” type freight vehicle; in which the dry-van or dry-trailer provides freight capacity for the system of the multiple mini-containers and the CDU and the CCU without any mechanism for providing power services, refrigeration services, or humidity control services. According to such an embodiment, the multiple mini-containers and the CDU and the CCU for a single inter-connected and aggregated stack providing: (i) power services via batteries or an internal combustion engine or both within the CDU, (ii) providing refrigeration services to the multiple mini-containers via a Vapor-Compression (VC) refrigeration unit or a Vapor-Compression Refrigeration System (VCRS) powered by the CDU, and (iii) providing humidity control services to the multiple mini-containers via a filtration and adsorber control unit powered by the CDU.

According to another embodiment of method 900-901, the transportation unit includes a non-refrigerated freight vehicle; in which the refrigerated freight vehicle provides power services without any mechanism for providing either refrigeration services or humidity control services. According to such an embodiment, the Central Driving Unit (CDU) couples with service interfaces of the non-refrigerated freight vehicle to receive the power services as a redundant power back-up to the CDU; and in which the Central Control Unit (CCU) and the Central Driving Unit (CDU) operate at least partially on batteries internal to the Central Driving Unit (CDU) and at least partially on the power services as provided by the non-refrigerated freight vehicle.

According to another embodiment of method 900-901, the transportation unit includes a refrigerated freight vehicle; in which the refrigerated freight vehicle provides power services, refrigeration services, and humidity control services. According to such an embodiment, the Central Driving Unit (CDU) couples with service interfaces of the refrigerated freight vehicle to receive the power services, refrigeration services, and humidity control services as redundant back-up services to the CDU; and in which the Central Control Unit (CCU) issues the control parameters for maintaining the specified atmosphere composition within each connected mini-container by instructing the CDU to at least partially utilize one or more of the power services, refrigeration services, and humidity control services as provided by the refrigerated freight vehicle.

According to another embodiment of method 900-901, the transportation unit includes one of: a land-transport tractor-trailer vehicle; a dry-trailer; a reefer or refrigerated trailer; a city cargo van; an air transport vehicle; a sea transport vehicle; a rail transport vehicle; and a shipping container configurable for transport via multiple transport vehicle types.

According to a particular embodiment, there is a non-transitory computer readable storage media having instructions stored thereupon that, when executed by a processor of a system, the instructions cause the system to perform operations including displaying at a Graphical User Interface (GUI) operator instructions for stacking multiple mini-containers into the transportation unit, displaying further operator instructions to the GUI for mechanically linking each of the multiple mini-containers into a single inter-connected and aggregated stack of the mechanically linked mini-containers; displaying further operator instructions to the GUI for connecting input connections on each of the multiple mini-containers to a centralized supply service; displaying further operator instructions to the GUI for connecting output connections on each of the multiple mini-containers to a centralized return service; displaying further operator instructions to the GUI for connecting a Central Driving Unit (CDU) to each of the centralized supply service and the centralized return service and providing services to each of the mini-containers to maintain the contents of each mini-container through the connected centralized supply service and the centralized return service; displaying further operator instructions to the GUI for connecting a Central Control Unit (CCU) with each of the CDU, the centralized supply service, and the centralized return service. And further wherein the instructions, when executed by the processor of the system, further cause the system to receive receiving sensor information at the CCU from each of the mini-containers and responsively issue control parameters for maintaining a specified atmosphere composition within each connected mini-container via the CDU. There are further instructions to execute the control parameters for maintaining the specified atmosphere composition within each connected mini-container by activating actuators, wherein the actuators manipulate valves at each mini-container, allowing for inflow and egress of atmospheric elements. According to such an embodiment, each of the multiple mini-containers constitute individual modular units configurable to form the single inter-connected and aggregated stack having a size which fits within the available volume of the transportation unit.

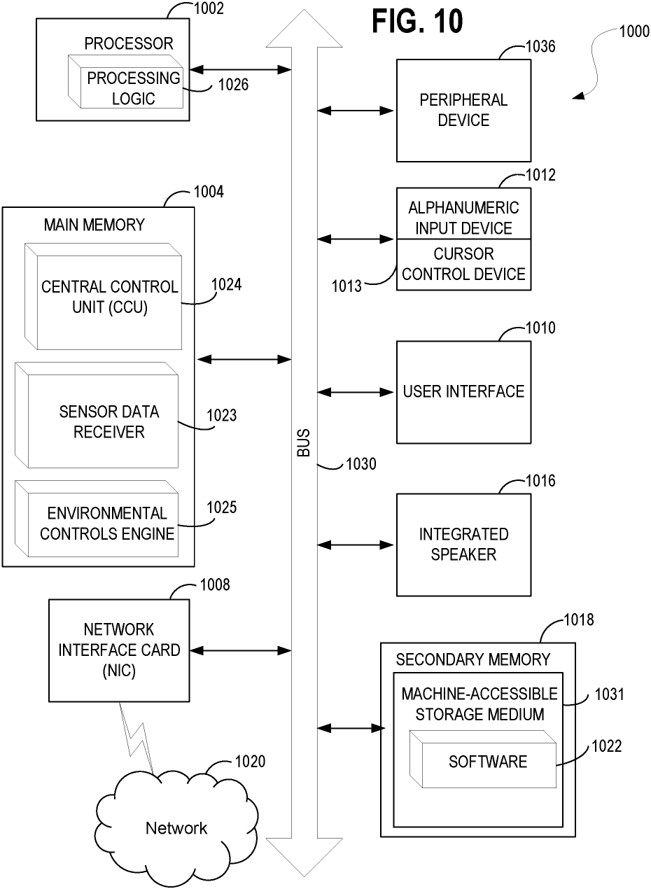

FIG. 10 illustrates a diagrammatic representation of a machine 1000 in the exemplary form of a computer system, in accordance with one embodiment, within which a set of instructions, for causing the machine/computer system 1000 to perform any one or more of the methodologies discussed herein, may be executed.

In alternative embodiments, the machine may be connected (e.g., networked) to other machines in a Local Area Network (LAN), an intranet, an extranet, or the public Internet. The machine may operate in the capacity of a server or a client machine in a client-server network environment, as a peer machine in a peer-to-peer (or distributed) network environment, as a server or series of servers within an on-demand service environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify and mandate the specifically configured actions to be taken by that machine pursuant to stored instructions. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 1000 includes a processor 1002, a main memory 1004 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 1018 (e.g., a persistent storage device including hard disk drives and a persistent database and/or a multi-tenant database implementation), which communicate with each other via a bus 1030. Main memory 1004 includes a Central Control Unit (CCU) 1024 having electro-mechanical actuators for providing electrical and atmospheric input controls to the various mini-containers. Main memory 1004 further includes a sensor data receiver 1023 capable of receiving sensor information from the CCU and from the mini-containers upon which environmental control instructions will be determined and issued. Main memory 1004 further includes the environmental controls engine 1025 which calculates appropriate control manipulations and instructions (e.g., to increase temperature or decrease humidity, etc.) based on received inputs and based further upon analysis applied by the environmental controls engine 1025 in furtherance of the methodologies and techniques described herein. Main memory 1004 and its sub-elements are further operable in conjunction with processing logic 1026 and processor 1002 to perform the methodologies discussed herein.

Processor 1002 represents one or more specialized and specifically configured processing devices such as a microprocessor, central processing unit, or the like. More particularly, the processor 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1002 may also be one or more special-purpose processing devices such as an application-specific integrated circuit (ASIC), a field-programmable gate array (FPGA), a digital signal processor (DSP), network processor, or the like. Processor 1002 is configured to execute the processing logic 1026 for performing the operations and functionality discussed herein.

The computer system 1000 may further include a network interface card 1008. The computer system 1000 also may include a user interface 1010 (such as a video display unit, a liquid crystal display, etc.), an alphanumeric input device 1012 (e.g., a keyboard), a cursor control device 1013 (e.g., a mouse), and a signal generation device 616 (e.g., an integrated speaker). The computer system 1000 may further include peripheral device 1036 (e.g., wireless or wired communication devices, memory devices, storage devices, audio processing devices, video processing devices, etc.).

The secondary memory 1018 may include a non-transitory machine-readable storage medium or a non-transitory computer readable storage medium or a non-transitory machine-accessible storage medium 1031 on which is stored one or more sets of instructions (e.g., software 1022) embodying any one or more of the methodologies or functions described herein. The software 1022 may also reside, completely or at least partially, within the main memory 1004 and/or within the processor 1002 during execution thereof by the computer system 1001, the main memory 1004, and the processor 1002 also constituting machine-readable storage media. The software 1022 may further be transmitted or received over a network 1020 via the network interface card 1008.

According to a particular embodiment, there is a system providing efficient transportation logistics of dissimilar perishable products within a transportation unit, wherein the system includes: multiple mini-containers, each being configurable to stack and aggregate to consume at least a portion of volume within the transportation unit; a Central Driving Unit (CDU) operable to provide services to each of the mini-containers to maintain the contents of each mini-container; a Central Control Unit (CCU) 1024 having at least a processor and a memory embodied therein and being specially configured to receive sensor information via the sensor data receiver 1023 from each of the mini-containers and further to issue control parameters from the environmental controls engine 1025 for maintaining a specified atmosphere composition within each connected mini-container via the CDU, and executing the control parameters for maintaining the specified atmosphere composition within each connected mini-container by activating actuators, wherein the actuators manipulate valves at each mini-container, allowing for inflow and egress of atmospheric elements. According to such an embodiment, each of the multiple mini-containers constitute individual modular units configurable to form a single inter-connected and aggregated stack having a size which fits within the available volume of the transportation unit. According to another variation of such an embodiment, the services provided by the Central Driving Unit (CDU) include at least conditioned air and moist humidified air to manage a specified atmosphere composition within each connected mini-container.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A system for providing efficient transportation logistics of dissimilar perishable products within a transportation unit, wherein the system comprises:
multiple mini-containers, each being configurable to stack and aggregate to consume at least a portion of volume within the transportation unit;
a Central Driving Unit (CDU) operable to provide services to each of the mini-containers to maintain the contents of each mini-container;
a Central Control Unit (CCU) to receive sensor information from each of the mini-containers and further to issue control parameters for maintaining a specified atmosphere composition within each connected mini-container via the CDU, wherein the CCU executes the control parameters for maintaining the specified atmosphere composition within each connected mini-container by activating actuators, wherein the actuators manipulate valves at each mini-container, allowing for inflow and egress of atmospheric elements; and
wherein each of the multiple mini-containers constitute individual modular units configurable to form a single inter-connected and aggregated stack having a size which fits within the available volume of the transportation unit.

2. The system of claim 1, wherein the services provided by the Central Driving Unit (CDU) include at least conditioned air and moist humidified air to manage a specified atmosphere composition within each connected mini-container.

3. The system of claim 2, wherein the services provided by the Central Driving Unit (CDU) further includes the removal or supply of atmospheric elements including one or more of: (i) atmospheric gases such as oxygen and nitrogen, (ii) greenhouse gases such as carbon dioxide, (iii) ethylene gas, (iv) temperature, and (v) relative humidity (RH) to one or more of the connected mini-containers.

4. The system of claim 1, wherein each of the CDU and the CCU are embodied within one or more mini-containers co-located with a plurality of additional mini-containers having perishable products contained therein.

5. The system of claim 1, wherein each connected mini-container includes its own traceable identifier.

6. The system of claim 1:
wherein each connected mini-container is associated with a distinct customer specifying a unique atmosphere composition for the associated mini-container uniquely identifiable via a traceable identifier corresponding each mini-container to only one of a plurality of distinct customers; and
wherein the CDU manages temperature and atmosphere controls for each of the distinct customers’ associated mini-container and prevents cross-contamination of perishable food products being shipped by each of the distinct customers by isolating the food products shipped by each of the distinct customers into separate mini-containers within the larger single inter-connected and aggregated stack being shipped within the available volume of the transportation unit.

7. The system of claim 1, wherein each connected mini-container includes specified atmosphere composition including at least a mandated temperature and humidity range which is maintained within each respective mini-container by the CDU and which is configurable to be different than other connected mini-containers.

8. The system of claim 1, wherein the CDU includes an internal combustion engine to re-charge batteries of the CDU, wherein the batteries provide stored energy to an HVAC system embodied within the CDU.

9. The system of claim 1, wherein the CDU includes rechargeable batteries and wherein the rechargeable batteries of the CDU receive external power when not in transport, wherein the batteries provide stored energy to the systems embodied within the CDU.

10. The system of claim 1:
wherein the transportation unit comprises one of a “dry-van” or a “dry-trailer” type freight vehicle;
wherein the dry-van or dry-trailer provides freight capacity for the system of the multiple mini-containers and the CDU and the CCU without any mechanism for providing power services, refrigeration services, or humidity control services;
wherein the multiple mini-containers and the CDU and the CCU for a single inter-connected and aggregated stack providing:
(i) power services via batteries or an internal combustion engine or both within the CDU,
(ii) providing refrigeration services to the multiple mini-containers via a Vapor-Compression (VC) refrigeration unit or a Vapor-Compression Refrigeration System (VCRS) powered by the CDU, and
(iii) providing humidity control services to the multiple mini-containers via a filtration and adsorber control unit powered by the CDU.

11. The system of claim 1:
wherein the transportation unit comprises a non-refrigerated freight vehicle;
wherein the refrigerated freight vehicle provides power services without any mechanism for providing either refrigeration services or humidity control services;
wherein the Central Driving Unit (CDU) couples with service interfaces of the non-refrigerated freight vehicle to receive the power services as a redundant power back-up to the CDU; and
wherein the Central Control Unit (CCU) and the Central Driving Unit (CDU) operate at least partially on batteries internal to the Central Driving Unit (CDU) and at least partially on the power services as provided by the non-refrigerated freight vehicle.

12. The system of claim 1:
wherein the transportation unit comprises a refrigerated freight vehicle;
wherein the refrigerated freight vehicle provides power services, refrigeration services, and humidity control services;
wherein the Central Driving Unit (CDU) couples with service interfaces of the refrigerated freight vehicle to receive the power services, refrigeration services, and humidity control services as redundant back-up services to the CDU; and
wherein the Central Control Unit (CCU) issues the control parameters for maintaining the specified atmosphere composition within each connected mini-container by instructing the CDU to at least partially utilize one or more of the power services, refrigeration services, and humidity control services as provided by the refrigerated freight vehicle.

13. The system of claim 1:
wherein the transportation unit comprises one of:
a land-transport tractor-trailer vehicle;
a dry-trailer;
a reefer or refrigerated trailer;
a city cargo van;
a small freight vehicle;
an air transport vehicle;
a sea transport vehicle;
a rail transport vehicle; and
a shipping container configurable for transport via multiple transport vehicle types.

14. A method for providing efficient transportation logistics of dissimilar perishable products within a transportation unit, wherein the method comprises:
stacking multiple mini-containers into the transportation unit, wherein each of the multiple mini-containers are configurable to stack and aggregate to consume at least a portion of volume within the transportation unit;
mechanically linking each of the multiple mini-containers into a single inter-connected and aggregated stack of the mechanically linked mini-containers;
connecting input connections on each of the multiple mini-containers to a centralized supply service;
connecting output connections on each of the multiple mini-containers to a centralized return service;
connecting a Central Driving Unit (CDU) to each of the centralized supply service and the centralized return service and providing services to each of the mini-containers to maintain the contents of each mini-container through the connected centralized supply service and the centralized return service;
connecting a Central Control Unit (CCU) with each of the CDU, the centralized supply service, and the centralized return service;
receiving sensor information at the CCU from each of the mini-containers and responsively issuing control parameters for maintaining a specified atmosphere composition within each connected mini-container via the CDU;
executing the control parameters for maintaining the specified atmosphere composition within each connected mini-container by activating actuators, wherein the actuators manipulate valves at each mini-container, allowing for inflow and egress of atmospheric elements; and
wherein each of the multiple mini-containers constitute individual modular units configurable to form the single inter-connected and aggregated stack having a size which fits within the available volume of the transportation unit.

15. The method of claim 14, wherein the services provided by the Central Driving Unit (CDU) include at least conditioned air and moist humidified air to manage a specified atmosphere composition within each connected mini-container.

16. The method of claim 15, wherein the services provided by the Central Driving Unit (CDU) further includes the removal or supply of atmospheric elements including one or more of: (i) atmospheric gases such as oxygen and nitrogen, (ii) greenhouse gases such as carbon dioxide, (iii) ethylene gas, (iv) temperature, and (v) relative humidity (RH) to one or more of the connected mini-containers.

17. The method of claim 14, wherein each of the CDU and the CCU are embodied within one or more mini-containers co-located with a plurality of additional mini-containers having perishable products contained therein.

18. The method of claim 14:
wherein each connected mini-container is associated with a distinct customer specifying a unique atmosphere composition for the associated mini-container uniquely identifiable via a traceable identifier corresponding each mini-container to only one of a plurality of distinct customers; and
wherein the CDU manages temperature and atmosphere controls for each of the distinct customers’ associated mini-container and prevents cross-contamination of perishable food products being shipped by each of the distinct customers by isolating the food products shipped by each of the distinct customers into separate mini-containers within the larger single inter-connected and aggregated stack being shipped within the available volume of the transportation unit.

19. The method of claim 14:
wherein each connected mini-container includes specified atmosphere composition including at least a mandated temperature and humidity range which is maintained within each respective mini-container by the CDU and which is configurable to be different than other connected mini-containers;
wherein the CDU includes an internal combustion engine to re-charge batteries of the CDU, wherein the batteries provide stored energy to an HVAC system embodied within the CDU; and
wherein the CDU further includes rechargeable batteries to provide stored energy to the systems embodied within the CDU.

20. The method of claim 14:
wherein the transportation unit comprises one of a “dry-van” or a “dry-trailer” type freight vehicle;
wherein the dry-van or dry-trailer provides freight capacity for the system of the multiple mini-containers and the CDU and the CCU without any mechanism for providing power services, refrigeration services, or humidity control services;
wherein the multiple mini-containers and the CDU and the CCU for a single inter-connected and aggregated stack providing:
(i) power services via batteries or an internal combustion engine or both within the CDU,
(ii) providing refrigeration services to the multiple mini-containers via a Vapor-Compression (VC) refrigeration unit or a Vapor-Compression Refrigeration System (VCRS) powered by the CDU, and
(iii) providing humidity control services to the multiple mini-containers via a filtration and adsorber control unit powered by the CDU.
